(19) United States
(12) Patent Application Publication
(10) Pub. No.: US 2011/0223335 A1
(43) Pub. Date: Sep. 15, 2011

(54) DEVICE FOR FORMING SURFACE PATTERN ON FLUID, AND FORMING METHOD THEREOF

(76) Inventors: Jae-Sung Yoon, Daejeon (KR); Doo-Sun Choi, Daejeon (KR); Yeong-Eun Yoo, Daejeon (KR)

(21) Appl. No.: 13/127,486

(22) PCT Filed: Feb. 10, 2009
(86) PCT No.: PCT/KR2009/000610

§ 371 Date: May 4, 2011

(30) Foreign Application Priority Data
Nov. 4, 2008 (KR) 10-2008-0108953

(51) Int. Cl. B05D 5/00; B05C 11/08

(52) U.S. Cl. 427/256; 118/612

(57) ABSTRACT

A device for forming a surface pattern of fluid includes: fluid that can be hardened under a predetermined condition; a base unit to which the fluid is applied; and a vibration unit for vibrating the applied fluid to form a waveform on a surface of the fluid. A method for forming a surface pattern of fluid includes: a fluid receiving stage for applying fluid to a base unit; a vibration stage for vibrating the fluid applied to the base unit to form a waveform on a surface of the fluid; and a hardening stage for hardening the fluid on which the waveform is formed. The disclosed device for forming a surface pattern of fluid and the forming method thereof have an advantage of easily forming various waveform patterns on the surface of the fluid by a vibration unit for vibrating the fluid with various waveforms, frequencies, and amplitudes. Also, the present invention enables the formation of waveform patterns on the surface of the fluid without mechanical contact with the surface of the fluid so there is little restriction in the waveform pattern size, and the production cost of the waveform pattern is reduced. Further, an additional precision mold for forming a fine waveform pattern on the surface of the fluid is not needed.

### TECHNICAL FIELD

The present invention relates to a fluid surface pattern forming device for forming a predetermined pattern on a surface of fluid such as a resin, and a forming method thereof.

### BACKGROUND ART

In general, a process for manufacturing a display device or a semiconductor device includes a plurality of pattern forming processes for patterning a surface of a layer that is applied on a substrate to have a desired form.

FIG. 1 is a schematic diagram for showing a surface pattern forming device according to conventional art and a forming method thereof.

The conventional surface pattern forming device and the forming method thereof provide a stamper 4 having a protruded and depressed lattice 4a on the surface as shown in FIG. 1 (a).

As shown in FIG. 1 (a) and FIG. 1 (b), the pattern with a protrusive and depressive lattice 4a is transferred to a resin 5 requiring pattern formation on the surface by pressing the protrusive and depressive lattice 4a of the stamper 4 to the resin 5 by performing a process such as hot press.

When the stamper 4 is removed, the resin 5 having a protrusive and depressive lattice 5a generated by transferring the protrusive and depressive lattice 4a of the stamper 4 is acquired as shown in FIG. 1 (c).

When the resin 5 is a thermoplastic resin, it can be manufactured through injection molding or extrusion molding.

However, the conventional surface pattern forming device and the formation method have the drawback of requiring a plurality of stampers 4 having various shapes of the protrusive and depressive lattice 4a so as to manufacture the protrusive and depressive lattice 5a with various shapes on the surface of the resin 5.

Also, the size of the pattern has a great limit since the pattern is formed on the surface of the resin 5 through transferring of the stamper 4

Further, the surface of the resin 5 requires a mechanical contact of the stamper 4 to increase the number of processes and thereby increase the production cost.

### DISCLOSURE

### Technical Problem

The present invention has been made in an effort to provide a device for forming a surface pattern of fluid for forming a pattern on a surface such as a resin without additional mechanical contact having the advantages of easily forming various patterns, having little restrictions of the pattern size, and reducing the production cost, and a method for forming the same.

### Technical Solution

An exemplary embodiment of the present invention provides a device for forming a surface pattern of fluid including: fluid that can be hardened under a predetermined condition; a base unit to which the fluid is applied; and a vibration unit for vibrating the applied fluid to form a waveform on a surface of the fluid.

The fluid is one of photoresist, resin, and UV resin.

The base unit is a semiconductor wafer or an LED chip.

The vibration unit is one of a mechanical vibrator for mechanically vibrating the fluid, a sonic wave vibrator for oscillating a sonic wave to vibrate the fluid, and an ultrasonic wave vibrator for oscillating an ultrasonic wave to vibrate the fluid.

The vibration unit can change a waveform, a frequency, and an amplitude.

Another embodiment of the present invention provides a method for forming a surface pattern of fluid including: a fluid receiving stage for applying fluid to a base unit; a vibration stage for vibrating the fluid applied to the base unit to form a waveform on a surface of the fluid; and a hardening stage for hardening the fluid on which the waveform is formed.

### Advantageous Effects

According to the embodiments of the present invention, the device for forming a surface pattern of fluid and the forming method thereof have an advantage of easily forming various waveform patterns on the surface of the fluid by a vibration unit for vibrating the fluid with various waveforms, frequencies, and amplitudes.

Also, the present invention enables the formation of waveform patterns on the surface of the fluid without mechanical contact so there is little restriction in the waveform pattern size, and the production cost of the waveform pattern is reduced. That is, an additional precision mold for forming a fine waveform pattern on the surface of the fluid is not needed.

### DESCRIPTION OF THE DRAWINGS

FIG. 1 shows a configuration diagram of a surface pattern forming device and method according to a conventional art,

FIG. 2 shows a conceptual diagram of a device for forming a surface pattern of fluid according to the present invention,

FIGS. 3 to 5 show perspective views of exemplary embodiments of device for forming a surface pattern of fluid according to the present invention, and

FIG. 6 shows a schematic diagram of a method for forming a surface pattern of fluid according to an exemplary embodiment of the present invention.

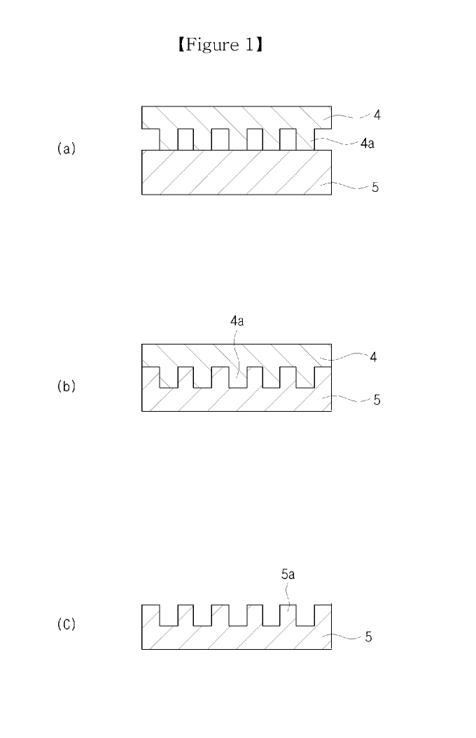

### MODE FOR INVENTION

An exemplary embodiment of the present invention will hereinafter be described in detail with reference to the accompanying drawings. In addition, terms or words that are used in the present specification and claims should be understood as meanings and concepts that correspond to the technical spirit of the present invention in consideration of the principle that the concept of the term can be appropriately defined in order to describe the invention by using the best method by the inventor.

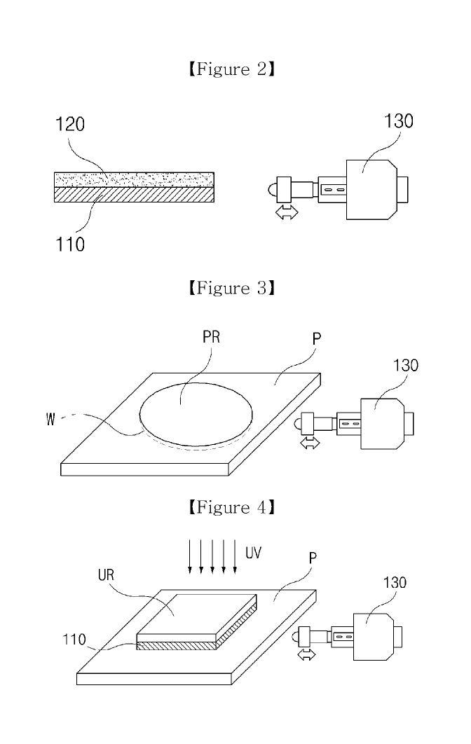

FIG. 2 shows a conceptual diagram of a device for forming a surface pattern of fluid according to the present invention, and FIGS. 3 to 5 show perspective views of exemplary embodiments of device for forming a surface pattern of fluid according to the present invention.

As shown in FIG. 2, the device for forming a surface pattern of fluid according to the present invention includes fluid 120 that can be hardened under a predetermined condition, a base unit 110 to which the fluid 120 is applied, and a vibration unit 130 for forming a waveform on a surface of the fluid 120 by vibrating the applied fluid 120.

Also, the device for forming a surface pattern of fluid desirably further includes a first image input unit for receiving an image of a surface pattern of fluid desired by a user, a second image input unit for receiving an image of the surface pattern of fluid formed by vibration by the vibration unit, a controller for comparing the images that are input to the first and second image input units and providing a feedback to the vibration unit, and a storage unit for comparing the images that are input to the first and second image input units, and when they correspond to each other, matching a corresponding surface pattern with condition information including a corresponding waveform, a frequency, and an amplitude condition, and storing them.

The fluid 120 is formed with one of photoresist (PR), resin (R), and UV resin (UR).

In this instance, the photoresist (PR) represents a photosensitive material that is changed to be a hard film with great chemical resistance when it is made into a thin film and light is applied to it. In detail, the photoresist (PR) is used to manufacture a printed wiring substrate, an integrated circuit, a high-density integrated circuit, and a newspaper printing board. In the present exemplary embodiment, the photoresist (PR) is applicable on a silicon wafer (W) to be used for the baking process, as shown in FIG. 3. That is, the silicon wafer (W) becomes the base unit 110, the photoresist (PR) is applied on the silicon wafer (W), and the silicon wafer (W) is loaded in the plate (P).

As an alternative method in the present exemplary embodiment, the fluid 120 can be made of the UV resin (UR). That is, as shown in FIG. 4, the UV resin (UR) is provided on the top surface of the base unit 110 that is loaded in the plate (P). In this instance, the UV resin (UR) indicates the ultraviolet ray resin (UV resin).

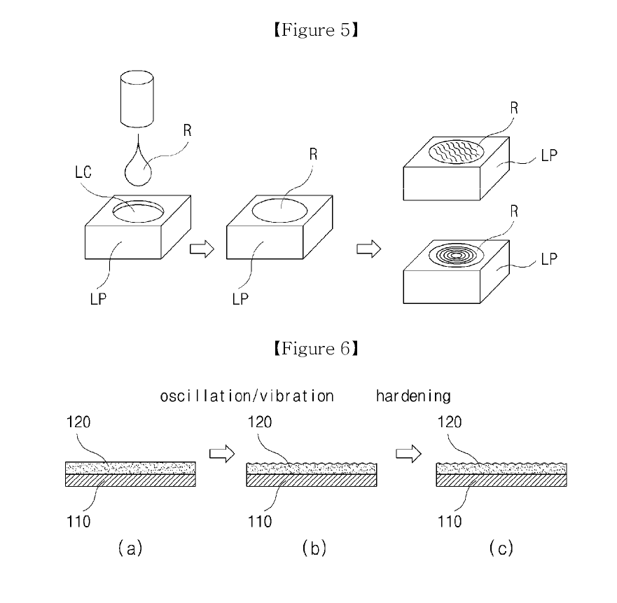

As another alternative, in the present exemplary embodiment, the fluid 120 can be used for the process for dispensing the resin (R) for encapsulation during the process for manufacturing an LED chip (LC). That is, as shown in FIG. 5, the base unit 110 corresponds to the LED chip formed in an LED package (LP), and the resin (R) that is the fluid 120 is applied on the top surface of LED chip (LC).

Regarding the predetermined condition in which the fluid 120 is hardened, as shown in FIG. 3, when the fluid 120 is the photoresist (PR), the photoresist (PR) is hardened by irradiating light to the photoresist (PR). Also, as shown in FIG. 4, when the fluid 120 is the UV resin (UR), the UV resin (UR) is hardened by irradiating the ultraviolet rays to the UV resin (UR). Further, as shown in FIG. 5, when the fluid 120 is the resin (R), the resin (R) is hardened by reducing the temperature to be lower than a solidus temperature. That is, the condition for hardening the fluid 120 includes irradiation of light, the temperature that is below the solidus temperature, and irradiation of ultraviolet rays.

The vibration unit 130 can be a mechanical vibrator, an ultrasonic wave vibrator, or a piezoelectric driver.

The vibration unit 130 is realized by one of a mechanical vibrator for mechanically vibrating the fluid 120, a sonic wave vibrator for vibrating the fluid by oscillating a sonic wave, and an ultrasonic wave vibrator for vibrating the fluid by oscillating an ultrasonic wave. The mechanical vibrator is mechanically connected to the base unit 110, the plate (P) in which the base unit 110 is loaded, or the LED package (LP) so as to mechanically vibrate the fluid 120.

In addition, the vibration unit 130 is provided to change the waveform, frequency, and amplitude. That is, a controller for changing the vibration waveform, frequency, and amplitude of the vibration unit 130 is provided so that various waveform patterns may be formed on the surface of the fluid 120.

An operational effect of the method for forming a surface pattern of fluid according to the present invention will now be described.

FIG. 6 shows a schematic diagram of a method for forming a surface pattern of fluid according to an exemplary embodiment of the present invention.

The method for forming a surface pattern of the fluid 120 according to the present invention includes: applying the fluid 120 to the base unit 110 to thus receive the fluid 120; vibrating the fluid 120 applied to the base unit 110 and forming a waveform on the surface of the fluid 120 to thus perform vibration; and hardening the waveform-formed fluid 120 to thus perform hardening.

In this instance, the surface pattern of the fluid 120 desired by the user can be input through the first image input unit, and the controller compares the images input through the first image input unit and the second image input unit, provides a feedback to the vibration unit, and controls the waveform, frequency, and amplitude of the vibration unit so that the image input through the first image input unit may correspond to the image input through the second image input unit. Also, when the image input through the first image input unit corresponds to the image input through the second image input unit, condition information including the waveform, frequency, and amplitude condition of the vibration unit is stored in the storage unit.

Regarding the method for forming a surface pattern of fluid shown in FIG. 6, the fluid 120 with liquidity is applied on the top surface of the base unit 110 as shown in FIG. 6 (a). Here, the silicon wafer (W) or the LED chip (LC) can be used for the base unit 110 as shown in FIG. 2 to FIG. 4. Further, the photoresist (PR), resin (R), or UV resin (UR) is usable for the fluid 120 as shown in FIG. 2 to FIG. 4.

The applied fluid 120 is vibrated after the stage of receiving the fluid 120 in which the fluid 120 is applied on the base unit 110, as shown in FIG. 6 (b). A waveform is formed on the surface of the fluid 120 by connecting the mechanical vibrator or the piezoelectric driver to the plate (P) in which the base unit 110 is loaded, or a waveform is formed on the surface of the fluid 120 by using the ultrasonic wave vibrator.

In detail, as shown in FIG. 3 to FIG. 5, in order to vibrate the photoresist (PR), UV resin (UR), or resin (R), the mechanical vibrator or the piezoelectric driver is connected to the plate (P) or the LED package (LP) to form a waveform on the photoresist (PR), UV resin (UR), or the surface of the resin (R), or the waveform is formed on the photoresist (PR), UV resin (UR), or the surface of the resin (R) by using the ultrasonic wave vibrator.

As shown in FIG. 6 (c), the fluid 120 with the surface on which the waveform is formed is hardened. That is, light is irradiated when the fluid 120 is the photoresist (PR), the temperature is controlled to be lower than the solidus temperature when it is the resin (R), and the ultraviolet rays are irradiated when it is the UV resin (UR).

In further detail according to the exemplary embodiments of the present invention, in FIG. 3, the photoresist (PR) is applied on the top surface of the silicon wafer (W), a waveform is formed on the surface of the photoresist (PR) by using the vibration unit 130, and light is irradiated to the photoresist (PR) to harden the photoresist (PR).

In FIG. 4, the UV resin (UR) is applied on the top surface of the base unit 110, a waveform is formed on the surface of the UV resin (UR) by using the vibration unit 130, and the ultraviolet rays are irradiated to the UV resin (UR) to harden the UV resin (UR).

In FIG. 5, the resin (R) is applied on the top surface of the LED chip (LC), a waveform is formed on the surface of the resin (R) by using the vibration unit 130, and the temperature of the resin (R) is reduced to be lower than the solidus temperature to harden the resin (R).

As shown in FIG. 6, the fluid 120 with the surface on which the waveform pattern is formed and hardened can be used as a master for plating as a merit.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

The Korea R&D Program having supported the present invention is the “21^{st} Frontier R&D Program” by Ministry of Education, Science and Technology, and the task tag is “08k1401-00530.”

The research project title is the “Nanoscale mechatronics & manufacturing technology,” and the research task title is the “Nanoscale injection molding process technology development” controllable by Korea Institute of Machinery & Materials and to be performed from Apr. 1, 2008 to Mar. 31, 2009.

### INDUSTRIAL APPLICABILITY

The device for forming a surface pattern of fluid and a method for forming the same according to the present invention can easily form various waveform patterns on the surface of the fluid by the vibration unit for vibrating the fluid with various waveforms, frequencies, and amplitudes, and they can form the waveform patterns with no mechanical contact on the surface of the fluid, so there is little restriction in the waveform pattern size and the production cost of the waveform patterns is reduced.

1. A device for forming a surface pattern of fluid comprising:
fluid that can be hardened under a predetermined condition;
a base unit to which the fluid is applied; and
a vibration unit for vibrating the applied fluid to form a waveform on a surface of the fluid.

2. The device of claim 1, wherein
the fluid is one of photoresist, resin, and UV resin.

3. The device of claim 1, wherein
the base unit is a semiconductor wafer or an LED chip.

4. The device of claim 1, wherein
the vibration unit is one of a mechanical vibrator for mechanically vibrating the fluid, a sonic wave vibrator for vibrating the fluid by oscillating a sonic wave, and an ultrasonic wave vibrator for vibrating the fluid by oscillating an ultrasonic wave.

5. The device of claim 1, wherein
the vibration unit can change a waveform, a frequency, and an amplitude.

6. A method for forming a surface pattern of fluid comprising:
a fluid receiving stage for applying fluid to a base unit;
a vibration stage for vibrating the fluid applied to the base unit to form a waveform on a surface of the fluid; and
a hardening stage for hardening the fluid on which the waveform is formed.
